(19) United States
(12) Patent Application Publication
(10) Pub. No.: US 2004/0267601 A1
(43) Pub. Date: Dec. 30, 2004

(54) Method, system, and storage medium for creating, implementing, and tracking a business strategy

(75) Inventor: David T. Angley, Brewster, NY (US)

Correspondence Address: Philmore H. Colburn II, CANTOR COLBURN LLP, 55 Griffin Road South, Bloomfield, CT, 06002, US

(73) Assignee: International Business Machines Corporation, Armonk, NY

(21) Appl. No.: 10/610,717

(22) Filed: Jun. 30, 2003

(51) Int. Cl. G06F 17/60

(52) U.S. Cl. 705/10

(57) ABSTRACT

An exemplary embodiment of the invention relates to a method, system, and storage medium for creating, implementing, and tracking a business strategy. The method comprises translating an abstract vision statement into measurable strategic attributes; utilizing the measurable strategic attributes to determine requirements for implementing the vision statement; and upon executing the business strategy, measuring ongoing effectiveness of the business strategy via the measurable strategic attributes. The requirements include business process requirements, data requirements, and technology requirements. Other embodiments include a system and a storage medium.

### BACKGROUND

This invention relates generally to business process solutions, and more particularly, the present invention relates to a method, system, and storage medium for creating, implementing, and tracking a business strategy.

Businesses are under increasing pressure to adapt their business models in response to heightened levels of competition and recent trends in globalization. Organizational responses to this have included web-based solutions and e-commerce initiatives. These solutions, however, cannot succeed without solid, end-to-end business processes that are capable of effectively managing strategies across all process lines. Accordingly, businesses find themselves continually striving for newer and better processes and methodologies by continuously reevaluating their business models and adapting to changes in the market.

It is often the case that business visions and strategies are created, but never implemented for various reasons. What has been lacking is the organizational structure and disciplined approach to creating and implementing a business strategy, particularly for those strategies that are highly complex. Without a systematic approach to implementing a business strategy, difficulties arise that can thwart the efforts of even the most diligent strategy teams.

What is needed, therefore, is a disciplined approach to effectuating a sound business strategy that will enhance overall business performance and operational efficiency.

### SUMMARY

An exemplary embodiment of the invention relates to a method, system, and storage medium for creating, implementing, and tracking a business strategy. The method comprises translating an abstract vision statement into measurable strategic attributes; utilizing the measurable strategic attributes to determine requirements for implementing the vision statement, and upon executing the business strategy, measuring ongoing effectiveness of the business strategy via the measurable strategic attributes. The requirements include business process requirements, data requirements, and technology requirements. Other embodiments include a system and a storage medium.

### BRIEF DESCRIPTION OF THE DRAWINGS

Referring now to the drawings wherein like elements are numbered alike in the several FIGURES:

FIG. 1 is a block diagram of a network system for creating, implementing, and tracking a business strategy via the transformation pyramid model application in an exemplary embodiment;

FIG. 2 is a diagram of the business strategy criteria comprising the transformation pyramid model in an exemplary embodiment;

FIG. 3 is a flowchart illustrating the process of creating, implementing, and tracking a business strategy in an exemplary embodiment; and

FIG. 4 is a sample computer screen window for initiating a new business strategy plan in an exemplary embodiment.

### DESCRIPTION OF THE PREFERRED EMBODIMENT

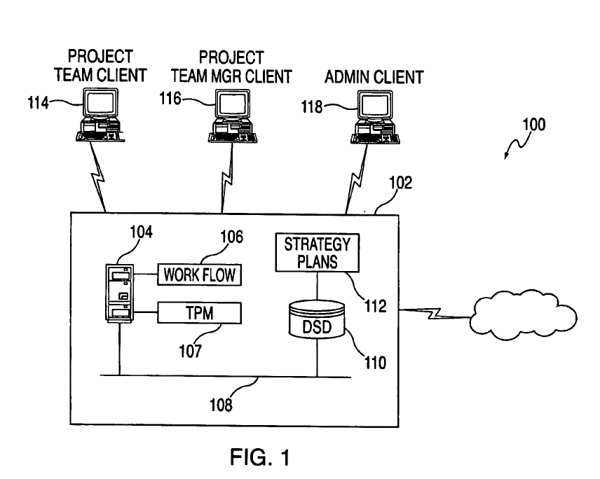

In an exemplary embodiment, the transformation pyramid model application 107 is implemented via a networked system such as that depicted in FIG. 1. System 100 may be part of a wide area network including multiple geographical locations that are interconnected by high-speed data lines or radio links. In the simplified diagram of FIG. 1, system 100 represents a global business enterprise. The term “business enterprise” as used herein, refers to the organization implementing the transformation pyramid model application 107.

System 100 includes a host system 102 and client systems 114-118 in communication with each other via the Internet. Host system 102 comprises a server 104 and a data storage device 110 connected by a network 108. Network 108 may comprise a LAN, a WAN, or other network configuration known in the art. Network 108 may include wireless technology, radio-based communications, telephony-based communications, or a combination of the above. For purposes of illustration, however, network 108 is a LAN Intranet. Access is limited to internal devices and applications through a firewall or similar security system (not shown) which protects system 100 from unauthorized access. The business enterprise preferably executes suitable multi-platform supported server software for creating secure, interactive Internet, Intranet, and Extranet applications, and which allows information stored in server 104 to be managed and presented to end users such as client systems 114-118 via business applications utilizing data management components (e.g., IBM's DB2™) as well as a presentation component (e.g., Lotus Domino™).

Server 104 executes the transformation pyramid model application 107 as well as a workflow application 106, among other applications. Server 104 allows the business enterprise of system 100 to maintain up-to-date information about business strategy plans, plan statuses, and overall efficiency of the transformation pyramid model process in a near real-time environment through its replication features and web browsers. Server 104 shares information with client systems 114-118, storing the most current data for access by user systems.

Each of client systems 114-118 may comprise a web-enabled personal computing device such as a desktop, laptop, or other similar apparatus known in the art. The term “client system” refers to any entity in communication with host system 102. Client systems are operated by employees or authorized representatives of the business enterprise.

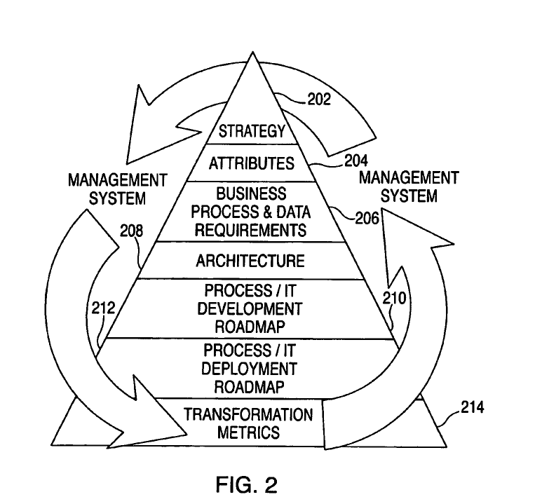

Client systems 114-118 may access server 104 via collaboration, application/data sharing, or standard web browsers (e.g. Lotus Notes™-compliant software, HTML based or Java enabled web applications, etc.) located on these client systems. Software may be Lotus Notes™ although it is not necessary in order to realize the advantages of the present invention. Individuals implement the transformation pyramid model 200 of FIG. 2 via one or more of client systems 114-118. For example, a project team member may initiate and/or assist in creating or implementing a strategy via client system 114. Likewise, a project team manager may initiate and/or assist in implementing a strategy via client system 116. Administrative client 118 refers to an executive entity that evaluates or manages the progress of the strategy implemented by client systems 114 and 116. It will be understood that any number of client systems may be utilized to implement the transformation pyramid model 200 and only three client systems are shown for illustrative purposes only. In a preferred embodiment, multiple client systems will collaborate on the creation and implementation of the strategies created via pyramid model 200.

Internal data storage of server 104 may comprise any form of mass storage device configured to read and write database type data maintained in a file store (e.g., a magnetic disk data storage device) and is logically addressable as a consolidated data source across a distributed environment such as system 100. The implementation of local and wide-area database management systems to achieve the functionality of the storage element will be readily understood by those skilled in the art.

Data repository 110 stores business information including strategy plans 112, including metrics and other information for implementing the transformation pyramid model application's 107 features and functions as described further herein. Data repository 110 is used throughout the transformation pyramid model process to facilitate the collection, creation, notification, review and collaboration of the information via workflow application 106 executing on server 104. Strategy plans 112 (also referred to as business strategy roadmaps) are described further herein.

It will be understood to those skilled in the art that server 104 and data repository 110 may comprise a single unit such as a mainframe computer or other high-speed processing system.

Transformation pyramid model application 107 provides a mechanism for developing and tracking a strategy plan of the business enterprise. A new or revised strategy plan may be triggered by marketplace or competitive data, customer input, customer or business needs, and/or business and transformation metrics results. The data collection and analysis process is driven by a disciplined and interactive management system that triggers the transformation pyramid process from top to bottom, the results of which may cause a second transformation cycle to be initiated.

The transformation pyramid model application 107 is tailorable to meet the needs of various business units of the business enterprise. It provides a disciplined approach to ensure each step in the process is completed correctly and on time. The pyramid model application 107 also provides a single, authoritative source of information readily accessible by authorized participants.

The transformation pyramid model 200 is implemented via transformation pyramid model application 107 and workflow application 106 executing on server 104. Transformation pyramid model application 107 uses transformation pyramid model criteria (see generally FIG. 2) and associated data provided by a user to create, implement, and track strategy plans 112. A strategy plan is created for each strategy (also referred to as vision statement) initiated and is stored in data storage device 110.

FIG. 2 illustrates the transformation pyramid model criteria in greater detail. It will be understood that each criteria segment supports and depends from the segments listed above it in the pyramid model 200. At the top of pyramid 200 is a strategy 202. The strategy should be expressed in simple terms and should be worded in such a way that is easy to understand and helps set the tone and urgency for the stakeholders or the strategy team involved. An example of a strategy may be to enhance the customer experience while buying from the business enterprise via the Web.

The second component of pyramid 200 is the strategic attributes criteria 204. The strategic attributes criteria further builds upon the strategy and refers to the measurable elements, capabilities, and/or functions of the strategy. For example, the attributes of the customer experience that are key to the strategy may be a quick response time and catalog browsing information that contains product information along with substitutions and alternatives, special pricing, and availability in days to ship and deliver. Another attribute may be to provide an order status at multiple points of the process (e.g., from order entry to delivery).

Business process requirements criteria 206 refers to actions or items that are needed to enable the measurable strategic attributes provided in segment 204. The business process requirements should be clearly articulated and documented. Further, the relationships between the attributes and the business process requirements that enable these attributes must be clearly understood. For example, a business requirement may be that there is a need to improve the response time to customer queries from days to seconds or minutes. Or, a business requirement may comprise moving product information into a Web or business-to-business environment so that it is self-serve rather than requiring contact with a customer sales or support entity. Another example of a business requirement may be to push order status information to the customer at key steps of the process at times where product constraints are in place or low availability times exist.

Architecture criteria 208 refers to the supporting Information Technology (IT) required to implement the strategy taking into account the supporting strategic attributes and business process requirements. A system architect performs a systems design review utilizing the business process requirements and create a plan based on the present specifics of the IT landscape (e.g, existing software, hardware, networks, etc). For example, it will be considered what kind of information, frequency, and detail is needed. It also may take into account whether a new invention or new technology is required or whether additional funding is needed. Factors such as whether a current business application or product can be enhanced to save time and expense in implementing the strategy may also be considered. This criteria may take in account whether a process change for people is necessary or desirable in order to implement the strategy.

Process, data, and IT infrastructure criteria 210 provides subject matter experts with the high level business requirements and IT requirements resulting from segments 206 and 208 allowing for extensive elaboration of the low level requirements needed to implement the strategy. These low level details serve as the foundation for a business strategy roadmap. This criteria requires a comprehensive project management discipline to handle the level of detail and complexity associated with the roadmap. An example of criteria 210 may be a documented formal response by a lead IT developer, systems engineer, and company CIO representative. An estimation of costs and time frame may be determined as part of criteria 210.

Process, data, and IT infrastructure deployment criteria 212 includes communications, education, change management, and project management disciplines and skills that will be required as a result of the requirements determined in above segments.

The strategic attributes supporting the strategy should be measured to ensure that the requirements and goals defined during the above criteria are met. This feature is provided via transformation metrics criteria segment 214. This criteria looks at the defined metrics that will ensure the successful deployment of the strategy. For example, the current response time may be measured and compared to the response times after scheduled enhancements are made. Another metric may be determining the extent of product content, customer pricing and product availability information that is available to customers.

The circular arrows of the transformation pyramid model 200 refer to a management system that is put in place and employed throughout execution of transformation pyramid model 200. The management system addresses issues, funding, and executive support to the initiative. This feature considers factors such as whether there were decisions during the course of the project that needed attention or whether there was real-time and open dialogue between the customer, systems architect, and IT developer. Another factor considered may be whether the project met the scope, budget and date goals.

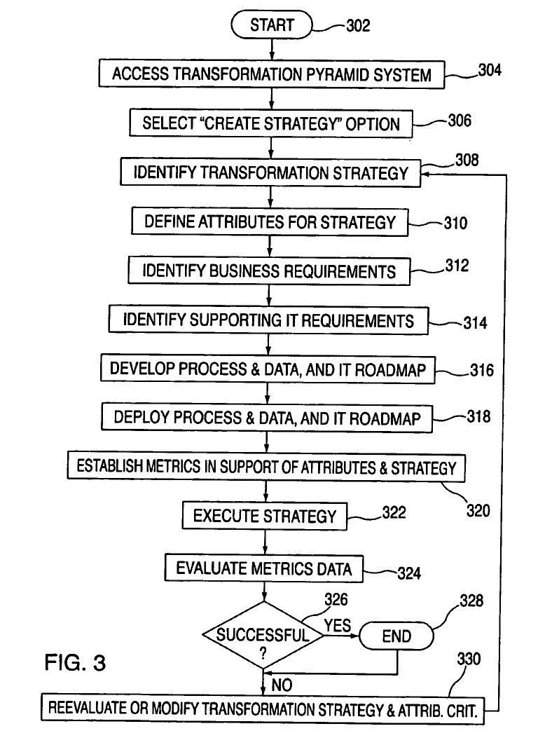

A framework for the flow of information associated with the implementation of the transformation pyramid model 200 is described in FIG. 3.

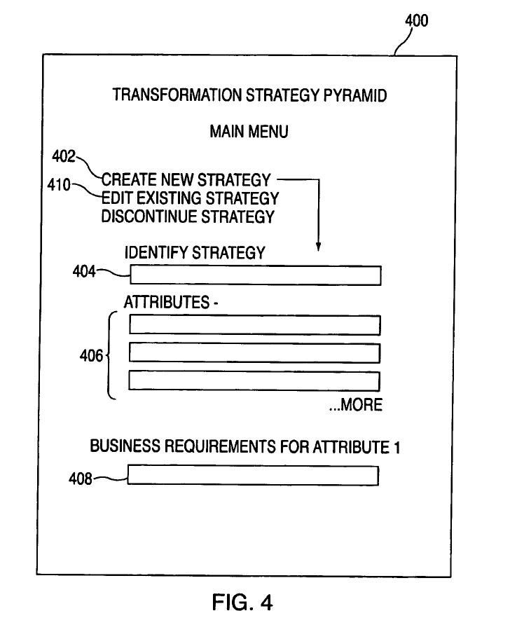

The process begins at step 302 where a user at one of client systems 114-118 accesses transformation pyramid model application 107 at step 304. A main menu screen 400 of FIG. 4 appears. The user selects the ‘create new strategy’ option 402 at step 306 and enters the vision statement via an editable text field 404 at step 308. The user then defines one or more strategic attributes for the vision statement in fields 406 at step 310. The user is then queried to enter one or more business requirements associated with the first strategic attribute shown in the first of fields 406 via text fields 408 at step 312. While not shown in FIG. 4, the user is prompted to enter business requirements for each of the strategic attributes listed in fields 406. In a ‘water flow’ type manner, the user builds on each succeeding pyramid segment utilizing the information provided in each preceding pyramid segment as described herein. This process continues for each pyramid segment shown in pyramid model 200.

At step 314, the user identifies the supporting IT requirements, followed by the process, data, and IT requirements resulting in a business strategy roadmap at step 316. At step 318, the business strategy roadmap is deployed. The user may enter metrics appropriate for the strategy criteria at step 320. At step 322, the business strategy roadmap is executed and tracked by workflow application 106. During execution, metrics are measured at step 324 and evaluated in accordance with the project management discipline in effect in order to determine ongoing effectiveness of the strategy roadmap. If the business strategy roadmap is found to be implementing satisfactorily at step 326, or if it has completed, the process ends at step 328. If the strategy roadmap is not implementing satisfactorily at step 326, then the strategy criteria may be modified by selecting the edit existing strategy option 410 of FIG. 4 in order to remedy the defect or deficiencies determined via the metrics process at step 330. The process then returns to step 308.

Transformation pyramid model provides a mechanism for developing and tracking a business strategy plan of the business enterprise. A new or revised strategy plan may be triggered by marketplace or competitive data, customer input, customer or business needs, and/or business and transformation metrics results. The data collection and analysis process is driven by a disciplined and interactive management system that triggers the transformation pyramid process from top to bottom.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for creating, implementing, and tracking a business strategy, comprising:
translating an abstract vision statement into measurable strategic attributes;
utilizing said measurable strategic attributes to determine requirements operable for implementing said vision statement, and
upon executing said business strategy, measuring ongoing effectiveness of said business strategy via said measurable strategic attributes;
wherein said requirements include business process requirements, data requirements, and technology requirements.

2. The method of claim 1, wherein determining said requirements operable for implementing said vision statement results in a business strategy roadmap deployable for executing said business strategy.

3. The method of claim 1, wherein said measuring ongoing effectiveness of said business strategy is performed using metrics based upon at least one of said measurable strategic attributes and said requirements.

4. The method of claim 1, wherein said requirements are refined if said measuring ongoing effectiveness of said business strategy results in a deficiency.

5. The method of claim 1, wherein said translating an abstract vision statement into measurable strategic attributes comprises:
further defining said vision statement by identifying at least one of an element, a capability, and a function of said vision statement.

6. The method of claim 1, wherein said business process requirements include action items needed to enable each of said measurable strategic attributes.

7. The method of claim 1, wherein said technology requirements include software, hardware, network, and system requirements needed to implement said vision statement, said technology requirements factoring in at least one of:
present technology conditions;
costs;
priority of vision statement;
said measurable strategic attributes; and
said business process requirements.

8. The method of claim 2, wherein said business strategy roadmap comprises detailed project plan items based upon said measurable strategic attributes, said business process requirements, said data requirements, and said technology requirements.

9. The method of claim 1, wherein said measurable strategic attributes are based upon said abstract vision statement.

10. The method of claim 9, wherein said business process requirements are based upon said measurable strategic attributes.

11. The method of claim 10, wherein said technology requirements are based upon said business process requirements and said measurable strategic attributes.

12. A storage medium comprising computer program code for creating, implementing, and tracking a business strategy, said storage medium including instructions for causing a computer to implement a method, comprising:
translating an abstract vision statement into measurable strategic attributes;
utilizing said measurable strategic attributes to determine requirements operable for implementing said vision statement; and
upon executing said business strategy, measuring ongoing effectiveness of said business strategy roadmap via said measurable strategic attributes;
wherein said requirements include business process requirements, data requirements, and technology requirements.

13. The storage medium of claim 12, wherein determining said requirements results in a business strategy roadmap deployable for executing said business strategy.

14. The storage medium of claim 1, wherein said measuring ongoing effectiveness of said business strategy is performed via pre-established metrics, said pre-established metrics based upon at least one of said measurable strategic attributes and said requirements.

15. The storage medium of claim 12, wherein said requirements are refined if said measuring ongoing effectiveness of said business strategy results in a deficiency.

16. The storage medium of claim 12, wherein said translating an abstract vision statement into measurable strategic attributes comprises:
further defining said vision statement by identifying at least one of an element, a capability, and a function of said vision statement.

17. The storage medium of claim 12, wherein said business process requirements include action items needed to enable each of said measurable strategic attributes.

18. The storage medium of claim 12, wherein said technology requirements include software, hardware, network, and system requirements needed to implement said vision statement, said technology requirements factoring in at least one of:
present technology conditions;
costs;
priority of vision statement;
said measurable strategic attributes; and
said business process requirements.

19. The storage medium of claim 13, wherein said business strategy roadmap comprises detailed project plan items based upon said measurable strategic attributes, said business process requirements, said data requirements, and said technology requirements.

20. The storage medium of claim 12, wherein said measurable strategic attributes are based upon said abstract vision statement.

21. The storage medium of claim 20, wherein said business process requirements are based upon said measurable strategic attributes.

22. The storage medium of claim 21, wherein said technology requirements are based upon said business process requirements and said measurable strategic attributes.

23. A system for creating, implementing, and tracking a business strategy, the system comprising:
a server;
a network in communication with said server;
a data repository in communication with said server;
business strategy roadmaps stored in said data repository;
a plurality of web-enabled client systems in communication with said server via said network;
a transformation pyramid model application executing on said server; and
a workflow application executing on said server;
wherein strategy criteria is determined via said transformation pyramid model application resulting in a business strategy roadmap.

24. The system of claim 23, wherein said strategy criteria includes:
a vision statement;
at least one measurable strategic attribute, said at least one measurable strategic attribute further defining said vision statement;
at least one business process requirement, said at least one business process requirement including action items operable for enabling said vision statement;
at least one data requirement;
at least one technology requirement based upon said at least one measurable attribute and said at least one business process requirement; and
metrics based upon said at least one measurable strategic attribute;
wherein effectiveness of said business strategy roadmap is measured utilizing said metrics.
